(19) United States
(12) Patent Application Publication
(10) Pub. No.: US 2018/0065696 A1
(43) Pub. Date: Mar. 8, 2018

(54) OUTDOOR EQUIPMENT COMPONENT

(71) Applicant: Shimano Inc., Osaka (JP)

(72) Inventors: Yuya YONEDA, Osaka (JP); Koujiro MORII, Osaka (JP)

(21) Appl. No.: 15/670,637

(22) Filed: Aug. 7, 2017

(30) Foreign Application Priority Data
Sep. 8, 2016 (JP) 2016-175683

(51) Int. Cl. B62J 1/08; B62M 6/90; H01M 2/10

(52) U.S. Cl. CPC B62J 1/08; H01M 2/1022; B62M 6/90

(57) ABSTRACT

An outdoor equipment component is provided for outdoor equipment that can be miniaturized. The outdoor equipment component includes a first member including an inner cavity and a second member at least partially located in the inner cavity. One of the first member and the second member includes a first projection and a second projection that project toward the other one of the first member and the second member. The one of the first member and the second member is integrally fixed to the other one of the first member and the second member at one or both of the first and second projections.

### CROSS-REFERENCE TO RELATED APPLICATIONS

This application claims priority to Japanese Patent Application No. 2016-175683, filed on Sep. 8, 2016. The entire disclosure of Japanese Patent Application No. 2016-175683 is hereby incorporated herein by reference.

### BACKGROUND

### Field of the Invention

The present invention generally relates to an outdoor equipment component for outdoor equipment.

### Background Information

Outdoor equipment is mainly used outdoor. An outdoor equipment component is a component that is included in outdoor equipment. One example of outdoor equipment is a bicycle. One example of an outdoor equipment component is a battery that is used in a bicycle. A conventional bicycle battery sometimes has a tubular configuration that can be inserted into a seatpost. A method for bonding a case body and a front lid in a bleeder case is disclosed in Japanese Laid-Open Patent Publication No. 2011-255683.

### SUMMARY

It is preferred that an outdoor equipment component for outdoor equipment be compact. It is an object of the present invention to provide an outdoor equipment component for outdoor equipment that can be miniaturized.

In a first aspect of the invention, an outdoor equipment component for outdoor equipment includes a first member including an inner cavity and a second member at least partially located in the inner cavity. One of the first member and the second member includes a first projection and a second projection that project toward the other one of the first member and the second member. The one of the first member and the second member is integrally fixed together at at least one of the first projection and the second projection. Since the second member is at least partially located in the inner cavity of the first member, the outdoor equipment component is miniaturized. Additionally, since at least one of the first member and the second member includes projections for integrally fixing the members, the members are easily fixed to each other.

In a second aspect of the invention, in the outdoor equipment component according to the first aspect, the second member includes the first projection and the second projection that project toward the first member. Since the second member is at least partially located in the inner cavity of the first member, the outdoor equipment component is miniaturized. Additionally, since the second member includes projections for integrally fixing the members, the members are easily fixed to each other.

In a third aspect of the invention, in the outdoor equipment component according to any one of the preceding aspects, the first member includes the first projection and the second projection that project toward the second member. Since the second member is at least partially located in the inner cavity of the first member, the outdoor equipment component is miniaturized. Additionally, since the first member includes projections for integrally fixing the members, the members are easily fixed to each other.

In a fourth aspect of the invention, an outdoor equipment component includes a first member including an inner cavity and a second member at least partially located in the inner cavity. One of the first member and the second member includes a first projection that projects toward the other one of the first member and the second member. The other one of the first member and the second member includes a second projection that projects toward the one of the first member and the second member. The one of the first member and the second member is integrally fixed together at at least one of the first projection and the second projection. Since the second member is at least partially located in the inner cavity of the first member, the outdoor equipment component is miniaturized. Additionally, since the first member and the second member each include a projection for integrally fixing the members, the members are easily fixed to each other.

In a fifth aspect of the invention, in the outdoor equipment component according to the fourth aspect, the second member includes the first projection that projects toward the first member. Since the second member is at least partially located in the inner cavity of the first member, the outdoor equipment component is miniaturized. Additionally, since the first member and the second member each include a projection for integrally fixing the members, the members are easily fixed to each other.

In a sixth aspect of the invention, in the outdoor equipment component according to the fourth aspect, the first member includes the second projection that projects toward the second member. Since the second member is at least partially located in the inner cavity of the first member, the outdoor equipment component is miniaturized, Additionally, since the first member and the second member each include a projection for integrally fixing the members, the members are easily fixed to each other.

In a seventh aspect of the invention, an outdoor equipment component includes a first member including an inner cavity and a second member at least partially located in the inner cavity. One of the first member and the second member includes at least one of a first projection and a second projection that project toward the other one of the first member and the second member. The one of the first member and the second member is integrally fixed together at at least one of the first projection and the second projection. The first member includes an inner surface. The second member includes an outer surface. The inner surface of the first member is spaced apart from the outer surface of the second member by a gap. Since the second member is at least partially located in the inner cavity of the first member, the outdoor equipment component is miniaturized. Additionally, since at least one of the first member and the second member includes at least one projection for integrally fixing the members, the members are easily fixed to each other.

In an eighth aspect of the invention, in the outdoor equipment component according to any one of the preceding aspects, the first member is a tubular member. This reduces the weight of the outdoor equipment component.

In a ninth aspect of the invention, in the outdoor equipment component according to any one of the preceding aspects, the second member is a tubular member. This reduces the weight of the outdoor equipment component.

In a tenth aspect of the invention, in the outdoor equipment component according to any one of the preceding aspects, the first member has a center axis. The second member has a center axis. The center axis of the first member is aligned with the center axis of the second member. This improves the weight balance of the outdoor equipment component.

In an eleventh aspect of the invention, in the outdoor equipment component according to any one of the first to seventh aspects, the first member and the second member are each a tubular member. The first member has a center axis. The second member has a center axis. The center axis of the first member is aligned with the center axis of the second member. At least one of the first projection and the second projection includes a curved portion that extends in a circumferential direction of at least one of the first member and the second member. The one of the first member and the second member is integrally fixed to the other one of the first member and the second member at the curved portion. This firmly fixes the first member and the second member.

In a twelfth aspect of the invention, in the outdoor equipment component according; to the eleventh aspect, the curved portion is annular. The one of the first member and the second member is integrally fixed to the other one of the first member and the second member at the at least one of the first projection and the second projection over an entire circumference of the curved portion about the center axis of at least one of the first member and the second member. Since the first member is fixed to the second member by a wider range, the first member is further firmly fixed to the second member.

In a thirteenth aspect of the invention, in the outdoor equipment component according; to any one of the preceding aspects, the first member has a center axis. The first projection is separated from the second projection in an axial direction parallel to the center axis of the first member. This easily allows the first projection and the second projection to have different functions.

In a fourteenth aspect of the invention, in the outdoor equipment component according to the thirteenth aspect, the first member includes an open end. The second projection is located closer to the open end than the first projection in the axial direction parallel to the center axis. This limits collection of a foreign substance on the first projection.

In a fifteenth aspect of the invention, in the outdoor equipment component according to the fourteenth aspect, the second projection is opposed to the open end. This limits entrance of a foreign substance into the inner cavity.

In a sixteenth aspect of the invention, in the outdoor equipment component according to any one of the preceding aspects, the second projection is at least partially located outside the first member. This limits collection of a foreign substance on the first projection.

In a seventeenth aspect of the invention, the outdoor equipment component according to any one of the preceding aspects further includes a relative rotation restriction mechanism. The first member has a center axis. The second member has a center axis. The relative rotation restriction mechanism restricts relative rotation of the first member and the second member about the center axis of at least one of the first member and the second member. Thus, the first member and the second member tend to maintain the appropriate fixing state even if receiving force that acts to displace the first member and the second member.

In an eighteenth aspect of the invention, in the outdoor equipment component according to any one of the preceding aspects, at least one of the first member and the second member is formed from a resin material. This reduces the weight of the outdoor equipment component.

In a nineteenth aspect of the invention, in the outdoor equipment component according to any one of the preceding aspects, the first member and the second member are fixed through welding. This further firmly fixes the first member and the second member.

In a twentieth aspect of the invention, in the outdoor equipment component according to any one of the preceding aspects, the first member and the second member define a bicycle battery housing for enclosing a bicycle battery. This allows for miniaturization of the bicycle battery.

The above outdoor equipment component can be miniaturized.

### BRIEF DESCRIPTION OF DRAWINGS

Referring now to the attached drawings which form a part of this original disclosure.

FIG. 1 is a side elevational view of a bicycle that includes a bicycle battery including a housing in accordance with a first embodiment.

FIG. 2 is an exploded perspective view of the bicycle battery shown in FIG. 1.

FIG. 3 is a perspective view of the bicycle battery shown in FIG. 1.

FIG. 4 is a cross-sectional view of a portion of the bicycle battery taken along line D4-D4 in FIG. 3.

FIG. 5 is a cross-sectional view, similar to FIG. 4, of a portion of a bicycle battery including a housing in accordance with a second embodiment.

FIG. 6 is a cross-sectional view, similar to FIG. 4, of a portion of a bicycle battery including a housing in accordance with a third embodiment.

FIG. 7 is a cross-sectional view, similar to FIG. 4, of a portion of a bicycle battery including a housing in accordance with a fourth embodiment.

FIG. 8 is a cross-sectional view, similar to FIG. 4, of a portion of a bicycle battery including a housing in accordance with a fifth embodiment.

FIG. 9 is a cross-sectional view, similar to FIG. 4, of a portion of a bicycle battery including a housing in accordance with a sixth embodiment.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

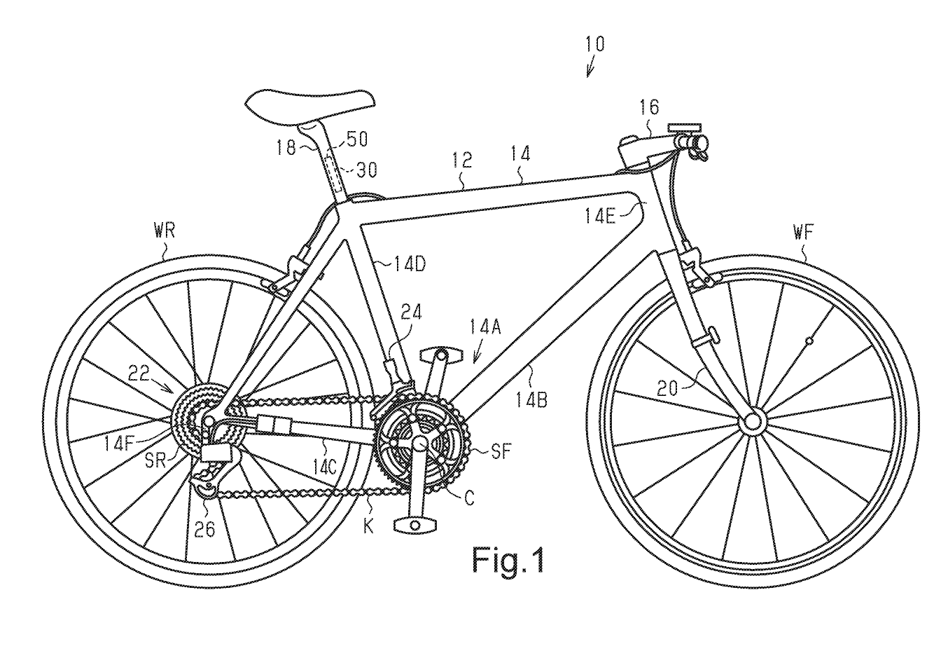

A structure of a bicycle 10 will now be described with reference to FIG. 1. The user uses the bicycle 10, for example, outdoor and indoor. The bicycle 10 includes a vehicle body 12 and a bicycle battery 30.

The vehicle body 12 includes a frame body 14, a handlebar 16, a seatpost 18, a front fork 20, a hub assembly 22, an electric front derailleur 24 and an electric rear derailleur 26.

The frame body 14 includes a bottom bracket 14A, a down tube 14B, a chainstay 14C, a seat tube 14D, a head tube 14E and a derailleur hanger 14F.

The bottom bracket 14A supports a crank axle C. The down tube 1413 extends frontward from the bottom bracket 14A. The chainstay 14C extends rearward from the bottom bracket 14A. The seat tube 14D extends upward from the bottom bracket 14A. The head tube 14E extends upward from the end of the down tube 14B opposite to the bottom bracket 14A. The derailleur hanger 14F is located at a rear end of the frame body 14.

The handlebar 16 is coupled to the head tube 14E in a removable manner. The seatpost 18 is hollow. The seatpost 18 is coupled to the seat tube 14D in a removable manner. The front fork 20 is supported by the head tube 14E. The front fork 20 connects the handlebar 16 and an axle of a front wheel WF. The hub assembly 22 is coupled around an axle of a rear wheel WR.

The electric front derailleur 24 is an electric transmission. The electric front derailleur 24 is coupled to the frame body 14 in a vicinity of the crank axle C. Preferably, the electric front derailleur 24 is coupled to the seat tube 14D. The electric front derailleur 24, which is driven by an actuator (not shown), changes a plurality of front sprockets SF, around which a chain K runs. This changes the gear ratio of the bicycle 10.

The electric rear derailleur 26 is an electric transmission. The electric rear derailleur 26 is coupled to the frame body 14 in a vicinity of the hub assembly 22. Preferably, the electric rear derailleur 26 is coupled to the derailleur hanger 14F. The electric rear derailleur 26, which is driven by an actuator (not shown), changes a plurality of rear sprockets SR, around which the chain K runs. This changes the gear ratio of the bicycle 10.

The bicycle battery 30 is located, for example, in the seatpost 18. The bicycle battery 30 is electrically connected to at least one of the electric front derailleur 24 and the electric rear derailleur 26 by a power line communication (PLC) cable 28 (refer to FIG. 3). The bicycle battery 30 supplies power to at least one of the electric front derailleur 24 and the electric rear derailleur 26 through the PLC cable 28.

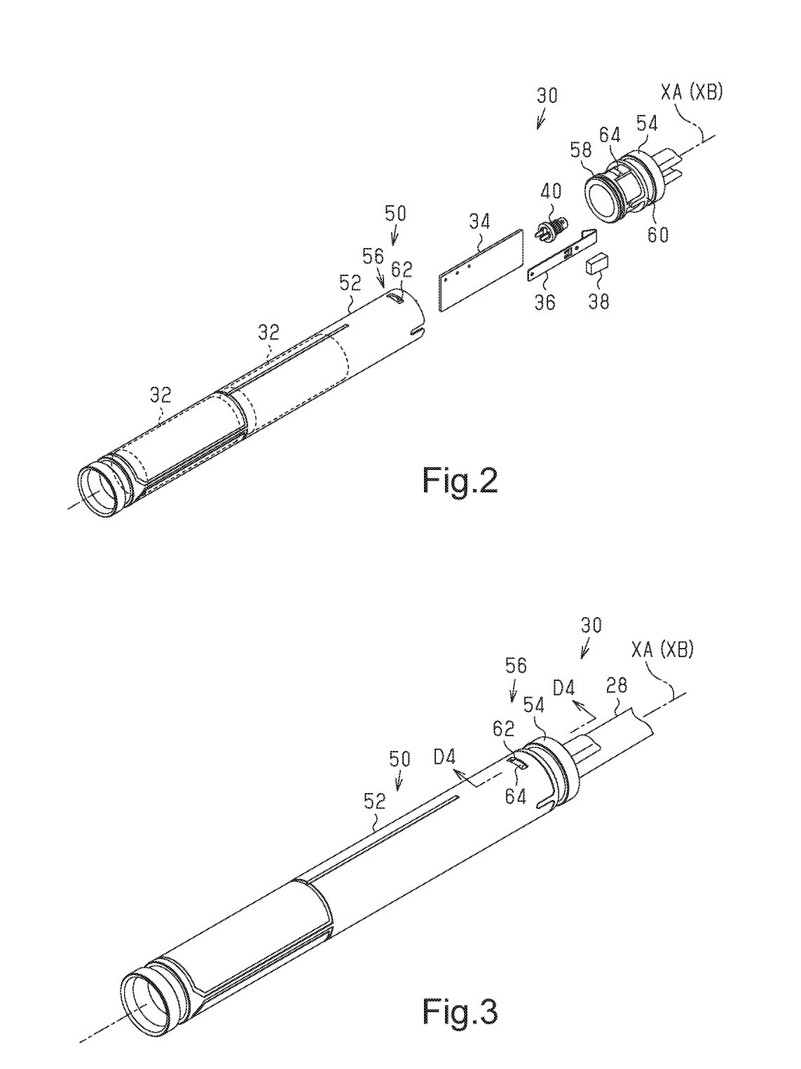

As shown in FIG. 2, the bicycle battery 30 includes a plurality of rechargeable batteries 32, a circuit board 34, a terminal 36, a terminal holder 38, a connector 40 and a housing 50. The rechargeable batteries 32 are tubular. One or more rechargeable batteries 32 are used. In the illustrated example, two rechargeable batteries 32 are used. One example of the rechargeable batteries 32 is a lithium-ion battery or a nickel-metal hydride battery. Thus, the housing 50 constitutes a bicycle battery housing.

The circuit board 34 is electrically connected to the rechargeable batteries 32. The terminal 36 is electrically connected to the circuit board 34. The terminal holder 38 supports the terminal 36. The connector 40 is connected to the terminal holder 38 and the PLC cable 28 (refer to FIG. 3).

The housing 50 is one example of the outdoor equipment component for outdoor equipment. The housing 50 accommodates the rechargeable batteries 32, the circuit board 34, the terminal 36, the terminal holder 38 and the connector 40. The housing 50 includes a first member 52 and a second member 54. Preferably, the housing 50 includes at least one relative rotation restriction mechanism 56. Here, the housing 50 includes has two of the relative rotation restriction mechanisms 56.

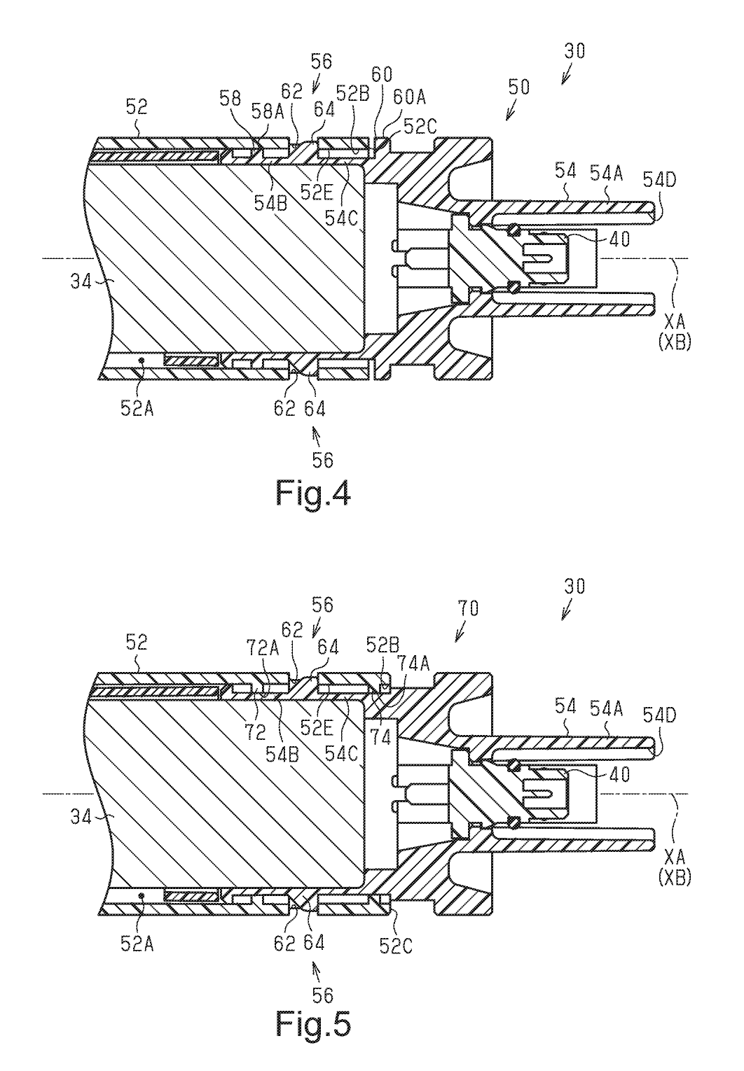

As shown in FIG. 4, the first member 52 is a tubular member. The first member 52 includes an inner cavity 52A (refer to FIG. 4). The first member 52 is formed from a resin material. The first member 52 has a center axis XA. The second member 54 has a center axis XB, which is aligned with the center axis XA of the first member 52. The first member 52 includes an opening 52B, into which the circuit board 34, the terminal 36, the terminal holder 38, the connector 40 and the second member 54 are inserted.

The second member 54 is a tubular member. The second member 54 is at least partially located in the inner cavity 52A. One of the first member 52 and the second member 54 includes a first projection 58 and a second projection 60. In the illustrated example, the second member 54 includes the first projection 58 and the second projection 60. The first projection 58 and the second projection 60 project toward the first member 52.

One of the first member 52 and the second member 54 is integrally fixed to the oiler one of the first member 52 and the second member 54 at at least one of the first projection 58 and the second projection 60. In the illustrated example, the first member 52 is integrally fixed to the second member 54 at the first projection 58. The first member 52 and the second member 54 are fixed, for example, through welding. One example of welding is laser welding performed through an absorbance control welding process.

At least one of the first projection 58 and the second projection 60 includes curved portions 58A and 60A. In the illustrated example, the first projection 58 includes the curved portion 58A. The second projection 60 includes the curved portion 60A. The curved portions 58A and 60A extend in a circumferential direction of at least one of the first member 52 and the second member 54. In the illustrated example, the curved portions 58A and 60A extend in the circumferential directions of the first member 52 and the second member 54.

One of the first member 52 and the second member 54 is integrally fixed to the other one of the first member 52 and the second member 54 at the curved portions 58A. 60A. In the illustrated example, the first member 52 is integrally fixed to the second member 54 at the curved portion 58A.

The curved portions 58A and 60A are annular portions. One of the first member 52 and the second member 54 is integrally fixed to the other one of the first member 52 and the second member 54 at at least one of the first projection 58 and the second projection 60 over the entire circumferences of the curved portions 58A and 60A about at least one of the center axes XA. XB of the first member 52 and the second member 54. In the illustrated example, the first member 52 is integrally fixed to the second member 54 at the first projection 58 over the entire circumference of the curved portion 58A about the center axis XA of the first member 52 and the center axis XB of the second member 54.

The first projection 58 is separated from the second projection 60 in an axial direction parallel to the center axis XA of the first member 52. The second projection 60 is located closer to an open end 52C of the opening 52B than the first projection 58 in an axial direction parallel to the center axis XB. The second projection 60 is at least partially located outside the first member 52. In the illustrated example, the second projection 60 is entirely located outside the first member 52. The second projection 60 projects further outward than the first projection 58 in a radial direction of the center axis XA.

The second member 54 further includes a first wall 54A, a second wall 54B and a third wall 54C. The first wall 54A is a portion that includes an opening 54D of the second member 54. Each of the relative rotation restriction mechanisms 56 includes a hook 64. The second wall 54B is a portion located between the first projection 58 and the hook 64 of the relative rotation restriction mechanism 56 in the direction parallel to the center axis XA. The third wall 54C is a portion located between the second projection 60 and the hook 64 in the direction parallel to the center axis XA. The first member 52 includes an inner surface 52E, which is spaced apart by a gap and opposed to the walls 54A, 54B and 54C.

The relative rotation restriction mechanisms 56 restrict the relative rotation of the first member 52 and the second member 54 about the center axis of at least one of the first member 52 and the second member 54. The relative rotation restriction mechanisms 56 are located at two positions separated by 180° in the circumferential direction of the first member 52 and the circumferential direction of the second member 54. Each of the relative rotation restriction mechanisms 56 includes a through hole 62 and the hook 64.

The first member 52 includes the through holes 62. The second member 54 includes the hooks 64. The hooks 64 are located between the first projection 58 and the second projection 60 in the direction parallel to the center axis XA. In a state in which the second member 54 is partially located in the inner cavity 52A of the first member 52, the hooks 64 of the second member 54 engage the through holes 62 in the first member 52. This restricts the relative rotation of the first member 52 and the second member 54.

The housing 50 has the advantages described below. It is difficult to integrally form the housing 50 because of its shape. Since the housing 50 is formed by fixing the first member 52 and the second member 54, the housing 50 is easily manufactured.

The second projection 60 closes the opening 52B of the first member 52. This improves the hermetic seal of the first member 52 and limits entrance of a foreign substance into the inner cavity 52A. The foreign substance is, for example, moisture or dust.

### Second Embodiment

A second embodiment of a housing 70 (i.e., an outdoor equipment component or a bicycle battery housing) will now be described with reference to FIG. 5. The same reference characters are given to those components that are the same as the corresponding components of the first embodiment. Such components will not be described,

In the housing 50 of the first embodiment, the second member 54 includes the first projection 58 and the second projection 60. In the housing 70 of the present embodiment, the first member 52 includes a first projection 72 and a second projection 74.

The first member 52 is integrally fixed to the second member 54 at the first projection 72 and the second projection 74. The first projection 72 includes a curved portion 72A. The curved portion 72A extends in the circumferential directions of the first member 52 and the second member 54. The second projection 74 includes a curved portion 74A. The curved portion 74A extends in the circumferential directions of the first member 52 and the second member 54. The first member 52 is integrally fixed to the second member 54 at the curved portions 72A and 74A.

The curved portions 72A and 74A are annular portions. The first member 52 is integrally fixed to the second member 54 at the first projection 72 and the second projection 74 over the entire circumferences of the curved portions 72A and 74A about the center axis XA of the first member 52 and the center axis XB of the second member 54.

The first projection 72 is separated from the second projection 74 in the axial direction parallel to the center axis XA of the first member 52. The second projection 74 is located closer to the open end 52C of the opening 52B than the first projection 72 in the axial direction parallel to the center axis XB. The second projection 74 is entirely located, in the inner cavity 52A of the first member 52. The second projection 74 closes the opening 52B of the first member 52.

### Third Embodiment

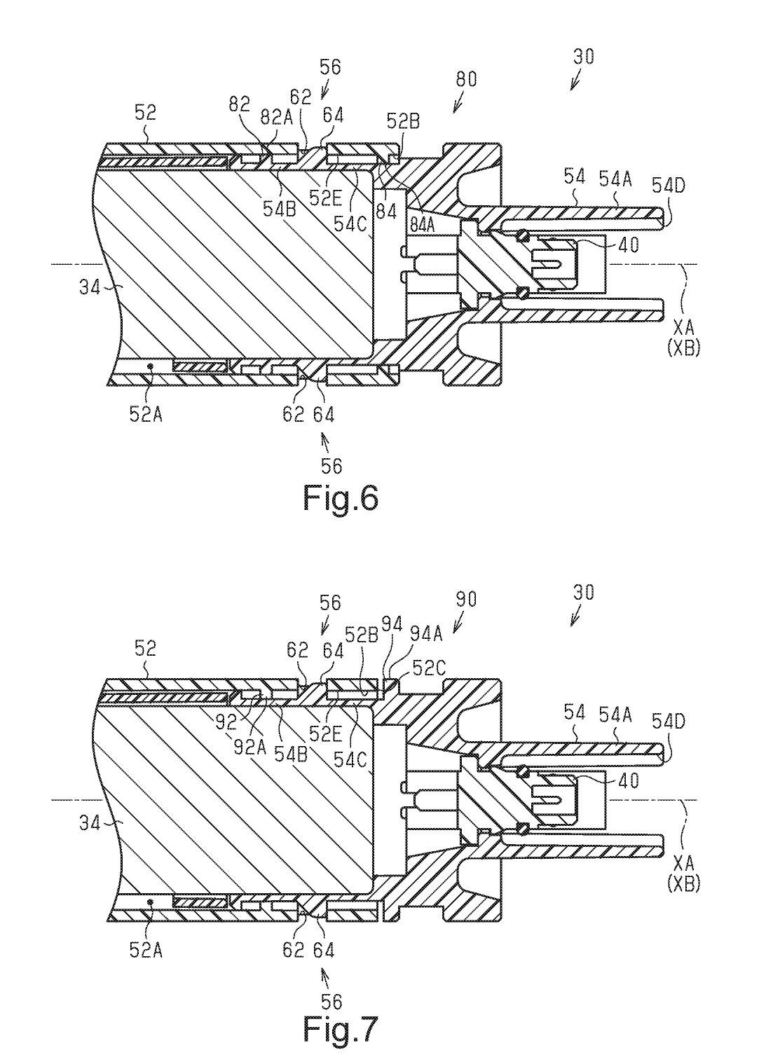

A third embodiment of a housing 80 (an outdoor equipment component or a bicycle battery housing) will now be described with reference to FIG. 6. The same reference characters are given to those components that are the same as the corresponding components of the first embodiment. Such components will not be described.

In the housing 50 of the first embodiment, the second member 54 includes the first projection 58 and the second projection 60. In the housing 80 of the present embodiment, one of the first member 52 and the second member 54 includes a first projection 82. The other one of the first member 52 and the second member 54 includes a second projection 84. In the illustrated example, the second member 54 includes the first projection 82, which projects toward the first member 52. The first member 52 includes the second projection 84, which projects toward the second member 54.

One of the first member 52 and the second member 54 is integrally fixed to the other one of the first member 52 and the second member 54 at at least one of the first projection 82 and the second projection 84. In the illustrated example, the first member 52 is integrally fixed to the second member 54 at the first projection 82. The second member 54 is integrally fixed to the first member 52 at the second projection 84.

The first projection 82 includes a curved portion 82A. The curved portion 82A extends in the circumferential directions of the first member 52 and the second member 54. The second projection 84 includes a curved portion 84A. The curved portion 84A extends in the circumferential directions of the first member 52 and the second member 54.

One of the first member 52 and the second member 54 is integrally fixed to the other one of the first member 52 and the second member 54 at the curved portions 82A, 84A. In the illustrated example, the first member 52 is integrally fixed to the second member 54 at the curved portion 82A. The second member 54 is integrally fixed to the first member 52 at the curved portion 84A.

The curved portions 82A and 84A are annular portions. The first member 52 is integrally fixed to the second member 54 at the first projection 82 over the entire circumference of the curved portion 82A about the center axis XA of the first member 52 and the center axis XB of the second member 54. The second member 54 is integrally fixed to the first member 52 at the second projection 84 over the entire circumference of the curved portion 84A about the center axis XA of the first member 52 and the center axis XB of the second member 54.

The first projection 82 is separated from the second projection 84 in the axial direction parallel to the center axis XA of the first member 52. The second projection 84 is located closer to the open end 52C of the opening 52B than the first projection 82 in the axial direction parallel to the center axis XB. The second projection 84 is entirely located in the inner cavity 52A of the first member 52. The second projection 84 closes the opening 52B of the first member 52.

### Fourth Embodiment

A fourth embodiment of a housing 90 (i.e., an outdoor equipment component or a bicycle battery housing) will now be described with reference to FIG. 7. The same reference characters are given to those components that are the same as the corresponding components of the first embodiment. Such components will not be described,

In the housing 50 of the first embodiment, the second member 54 includes the first projection 58 and the second projection 60. In the housing 90 of the present embodiment, the first member 52 includes a first projection 92. The second member 54 includes a second projection 94.

The first member 52 is integrally fixed to the second member 54 at the first projection 92. The second member 54 is not integrally fixed to the first member 52 at the second projection 94.

The first projection 92 projects toward the second member 54. The first projection 92 includes a curved portion 92A. The curved portion 92A extends in the circumferential directions of the first member 52 and the second member 54. The second projection 94 includes a curved portion 94A. The curved portion 94A extends in the circumferential directions of the first member 52 and the second member 54. The first member 52 is integrally boded to the second member 54 at the curved portion 92A.

The curved portions 92A and 94A are annular portions. The first member 52 is integrally fixed to the second member 54 at the first projection 92 over the entire circumference of the curved portion 92A about the center axis XA of the first member 52 and the center axis XB of the second member 54.

The first projection 92 is separated from the second projection 94 in the axial direction parallel to the center axis XA of the first member 52. The second projection 94 projects toward the first member 52. The second projection 94 is located closer to the open end 52C of the opening 52B than the first projection 92 in the axial direction parallel to the center axis XB. The second projection 94 is entirely located outside the first member 52. The second projection 94 is opposed to the open end 52C. The second projection 94 closes the opening 52B of the first member 52.

### Fifth Embodiment

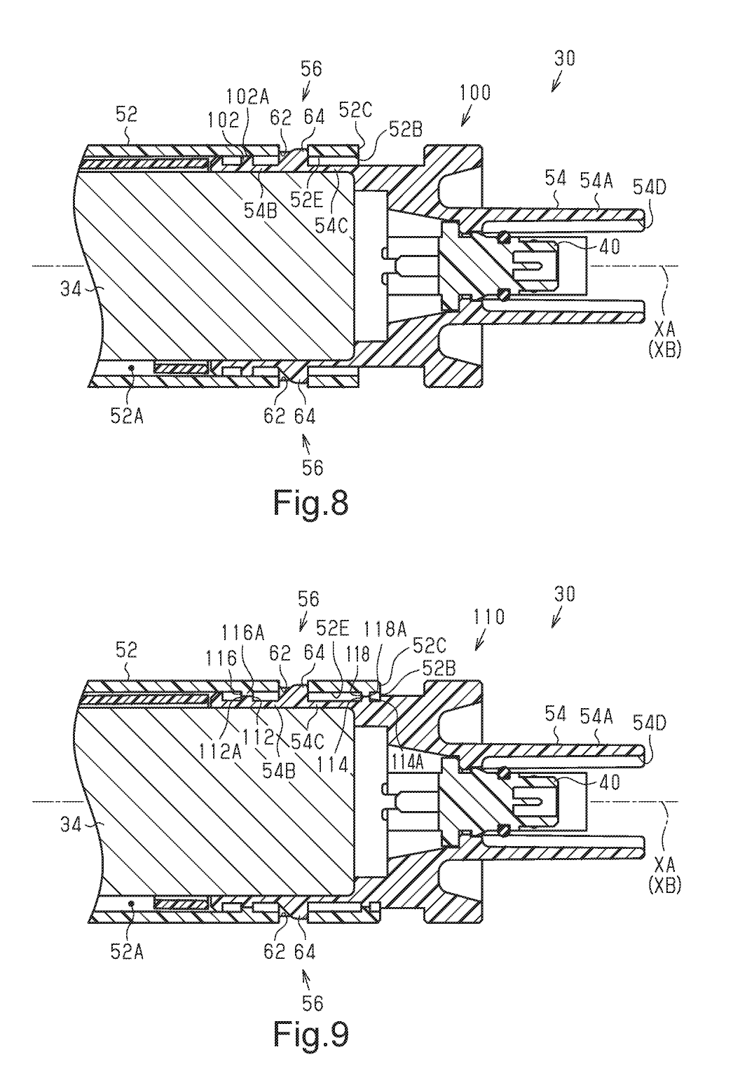

A fifth embodiment of a housing 100 (i.e., an outdoor equipment component or a bicycle battery housing) will now be described with reference to FIG. 8. The same reference characters are given to those components that are the same as the corresponding components of the first embodiment. Such components will not be described.

In the housing 50 of the first embodiment, the second member 54 includes the first projection 58 and the second projection 60. In the housing 100 of the present embodiment, one of the first member 52 and the second member 54 includes a first projection 102. In the illustrated example, the second member 54 includes the first projection 102.

The first member 52 is integrally fixed to the second member 54 at the first projection 102. The inner surface 52E of the first member 52 is spaced apart by a gap and opposed to the walls 54A, 54B and 54C. Thus, the first member 52 is spaced apart from the outer surface of the second member 54 by the gap.

The first projection 102 projects toward the other one of the first member 52 and the second member 54. The first projection 102 includes a curved portion 102A. The curved portion 102A extends in the circumferential directions of the first member 52 and the second member 54. The first member 52 is integrally fixed to the second member 54 at the curved portion 102A.

The curved portion 102A is annular. The first member 52 is integrally fixed to the second member 54 at the first projection 102 over the entire circumference of the curved portion 102A about the center axis XA of the first member 52 and the center axis XB of the second member 54.

### Sixth Embodiment

A sixth embodiment of a housing 110 (i.e., an outdoor equipment component or a bicycle battery housing) will now be described with reference to FIG. 9. The same reference characters are given to those components that are the same as the corresponding components of the first embodiment. Such components will not be described.

In the housing 50 of the first embodiment, the second member 54 includes the first projection 58 and the second projection 60. In the housing 110 of the present embodiment, the second member 54 includes a first projection 112 and a second projection 114. The first member 52 includes a third projection 116 and a fourth projection 118.

The first member 52 is integrally fixed to the second member 54 at the first projection 112 and the second projection 114. The second member 54 is integrally fixed to the first member 52 at the third projection 116 and the fourth projection 118.

The first projection 112 and the second projection 114 project toward the first member 52. The first projection 112 includes a curved portion 112A. The second projection 114 includes a curved portion 114A. The curved portion 112A and the curved portion 114A extend in the circumferential directions of the first member 52 and the second member 54.

The third projection 116 and the fourth projection 118 project toward the second member 54. The third projection 116 includes a curved portion 116A. The fourth projection 118 includes a curved portion 118A. The curved portion 116A and the curved portion 118A extend in the circumferential directions of the first member 52 and the second member 54.

The curved portions 112A, 114A, 116A and 118A are annular portions. The curved portion 112A and the curved portion 116A are integrally fixed to each other over the entire circumferences of the curved portions 112A and 116A about the center axis XA of the first member 52 and the center axis XB of the second member 54. The curved portion 114A and the curved portion 118A are integrally fixed to each other over the entire circumferences of the curved portions 114A and 118A about the center axis XA of the first member 52 and the center axis XB of the second member 54.

The first projection 112 is separated from the second projection 114 in the axial direction parallel to the center axis XB of the second member 54. The third projection 116 is separated from the fourth projection 118 in the axial direction parallel to the center axis XA of the first member 52.

The second projection 114 is located closer to the open end 52C of the opening 52B than the first projection 112 in the axial direction parallel to the center axis XB. The second projection 114 is entirely located in the inner cavity 52A of the first member 52.

The fourth projection 118 is located closer to the open end 52C of the opening 52B than the third projection 116 in the axial direction parallel to the center axis XA. The fourth projection 118 is entirely located in the inner cavity 52A of the first member 52. The second projection 114 and the fourth projection 118 close the opening 52B of the first member 52.

### Modified Examples

The outdoor equipment component is not limited to the embodiments described above. The outdoor equipment component can be embodied in other modes. Examples of other modes of the outdoor equipment component include modified examples described below.

In a modified example of the first embodiment of the housing 50, the first projection 58 and the second projection 60 are fixed to the first member 52. Alternatively, the second projection 60 is fixed to the first member 52, and the first projection 58 is not fixed to the first member 52. In a modified example of the housing 90 of the fourth embodiment, the first projection 92 is fixed to the second member 54, and the second projection 94 is fixed to the first member 52. Alternatively, the second projection 94 is fixed to the first member 52, and the first projection 92 is not fixed to the second member 54.

In a modified example of the housing 70 of the second embodiment, one of the first projection 72 and the second projection 74 is not fixed to the second member 54. In a modified example of the housing 80 of the third embodiment, the first projection 82 is not fixed to the first member 52. Alternatively, the second projection 84 is not fixed to the second member 54. In a modified example of the housing 110 of the sixth embodiment, the first projection 112 is not fixed to the third projection 116. Alternatively, the second projection 114 is not fixed to the fourth projection 118.

In a modified example of the housing 50 of the first embodiment, one of the first projection 58 and the second projection 60 is omitted. In a modified example of the housing 70 of the second embodiment, one of the first projection 72 and the second projection 74 is omitted. In a modified example of the housing 80 of the third embodiment, one of the first projection 82 and the second projection 84 is omitted. In a modified example of the housing 90 of the fourth embodiment, one of the first projection 92 and the second projection 94 is omitted. In a modified example of the housing; 110 of the sixth embodiment, the first projection 112 and the third projection 116 are omitted. Alternatively, the second projection 114 and the fourth projection 118 are omitted.

In a modified example of each of the housings 50, 70, 80, 90, 100 and 110 of the first to sixth embodiments, the first member 52 has the form of a tetragonal tube. In a modified example of each of the housings 50, 70, 80. 90, 100 and 110 of the first to sixth embodiments, the second member 54 is solid.

in a modified example of each of the housings 50, 70, 80, 90, 100 and 110 of the first to sixth embodiments, the center axis XA of the first member 52 is not aligned with the center axis XB of the second member 54.

A modified example of each of the housings 50, 70, 80, 90, 100 and 110 of the first to sixth embodiments is used as a housing for a battery of an electric fishing reel.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated. Also, it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. Finally, terms of degree such as “substantially”, “about” and “approximately” as used herein mean an amount of deviation of the modified term such that the end result is not significantly changed.

The foregoing descriptions of the embodiments according to the present invention are provided for illustration only, and not for the purpose of limiting the invention as defined by the appended claims and their equivalents.

What is claimed is:

1. An outdoor equipment component for outdoor equipment comprising:
a first member including an inner cavity; and
a second member at least partially located in the inner cavity, one of the first member and the second member including a first projection and a second projection that project toward the other one of the first member and the second member, and
the first member and the second member being integrally fixed together east one of the first projection and the second projection.

2. The outdoor equipment component according to claim 1, wherein
the second member includes the first projection and the second projection that project toward the first member.

3. The outdoor equipment component according to claim 1, wherein
the first member includes the first projection and the second projection that project toward the second member.

4. An outdoor equipment component for outdoor equipment comprising:
a first member including an inner cavity; and
a second member at least partially located in the inner cavity,
one of the first member and the second member including a first projection that projects toward the other one of the first member and the second member,
the other one of the first member and the second member includes a second projection that projects toward the one of the first member and the second member, and
the first member and the second member being integrally fixed together at at least one of the first projection and the second projection.

5. The outdoor equipment component according to claim 4, wherein
the second member includes the first projection that projects toward the first member.

6. The outdoor equipment component according to claim 4, wherein
the first member includes the second projection that projects toward the second member.

7. An outdoor equipment component for outdoor equipment comprising:
a first member including an inner cavity; and
a second member at least partially located in the inner cavity,
one of the first member and the second member including at least one of a first projection and a second projection that project toward the other one of the first member and the second member,
the first member and the second member being integrally fixed together at at least one of the first projection and the second projection,
the first member including an inner surface,
the second member including an outer surface, and
the inner surface of the first member being spaced apart from the outer surface of the second member by a gap.

8. The outdoor equipment component according to claim 1, wherein
the first member is a tubular member.

9. The outdoor equipment component according to claim 1, wherein
the second member is a tubular member.

10. The outdoor equipment component according to claim 1, wherein
the first member has a center axis,
the second member has a center axis, and
the center axis of the first member is aligned with the center axis of the second member.

11. The outdoor equipment component according to claim 1, wherein
the first member and the second member are each a tubular member,
the first member has a center axis,
the second member has a center axis,
the center axis of the first member is aligned with the center axis of the second member,
at least one of the first projection and the second projection includes a curved portion that extends in a circumferential direction of at least one of the first member and the second member, and
the one of the first member and the second member is integrally fixed to the other one of the first member and the second member at the curved portion.

12. The outdoor equipment component according to claim 11, wherein
the curved portion is annular, and
the one of the first member and the second member is integrally fixed to the other one of the first member and the second member at the at least one of the first projection and the second projection over an entire circumference of the curved portion about the center axis of at least one of the first member and the second member.

13. The outdoor equipment component according to claim 1, wherein
the first member has a center axis, and
the first projection is separated from the second projection in an axial direction parallel to the center axis of the first member.

14. The outdoor equipment component according to claim 13, wherein
the first member includes an open end, and
the second projection is located closer to the open end than the first projection in the axial direction parallel to the center axis.

15. The outdoor equipment component according to claim 14, wherein
the second projection is opposed to the open end.

16. The outdoor equipment component according to claim 1, wherein
the second projection is at least partially located outside the first member.

17. The outdoor equipment component according to claim 1, further comprising:
a relative rotation restriction mechanism,
the first member has a center axis,
the second member has a center axis, and
the relative rotation restriction mechanism restricts relative rotation of the first member and the second member about the center axis of at least one of the first member and the second member.

18. The outdoor equipment component according to claim 1, wherein
at least one of the first member and the second member is formed from a resin material.

19. The outdoor equipment component according to claim 1, wherein
the first member and the second member are fixed through welding.

20. The outdoor equipment component according to claim 1, wherein
the first member and the second member define a bicycle battery housing for enclosing a bicycle battery.
